(19) United States
(12) Patent Application Publication
(10) Pub. No.: US 2025/0005370 A1
(43) Pub. Date: Jan. 2, 2025

(54) MULTITASK PROMPT TUNING FOR PARAMETER-EFFICIENT TRANSFER LEARNING

(71) Applicants: International Business Machines Corporation, Armonk, NY (US); Massachusetts Institute of Technology, Cambridge, MA (US)

(72) Inventors: Rameswar Panda, Medford, MA (US); Zhen Wang, Columbus, OH (US); LEONID KARLINSKY, Acton, MA (US); Rogerio Schmidt Feris, West Hartford, CT (US); Yoon Hyung Kim, Cambridge, MA (US)

(21) Appl. No.: 18/216,533

(22) Filed: Jun. 29, 2023

(51) Int. Cl. G06N 3/096

(52) U.S. Cl. CPC G06N 3/096

(57) ABSTRACT

A source task prompt of each of a plurality of source tasks is decomposed as a multiplication of a shared prompt matrix shared across source tasks and a low-rank task-specific matrix. Prompt distillation is performed to transfer multitask knowledge to the shared prompt matrix by distilling knowledge from the source task prompts. Low-rank multiplicative updates are performed to the shared prompt matrix to transfer the multitask knowledge to one or more target tasks. The one or more target tasks (e.g., natural language processing) are carried out in accordance with the transferred knowledge

### BACKGROUND

The present invention relates generally to the electrical, electronic and computer arts and, more particularly, to machine learning and artificial intelligence.

Prompt tuning, in which a base pretrained model is adapted to each task via conditioning on learned prompt vectors, has emerged as a promising approach for the efficient adaptation of large language models to multiple downstream tasks. However, existing methods typically learn soft prompt vectors from scratch, and it has not been clear how to exploit the rich cross-task knowledge in task-specific prompt vectors to improve the performance on target downstream tasks.

### BRIEF SUMMARY

Principles of the invention provide systems and techniques for multitask prompt tuning for parameter-efficient transfer learning. In one aspect, an exemplary method includes the operations of decomposing, using a hardware processor, a source task prompt of each of a plurality of source tasks as a multiplication of a shared prompt matrix shared across the source tasks and a low-rank task-specific matrix; performing, using the hardware processor, prompt distillation to transfer multitask knowledge to the shared prompt matrix by distilling knowledge from the source task prompts; and performing, using the hardware processor, low-rank multiplicative updates to the shared prompt matrix to transfer the multitask knowledge to one or more target tasks; and carrying out the one or more target tasks in accordance with the transferred knowledge. The technological field of computerized conversational systems can accordingly be improved in cases where available data is limited (e.g., using prompt distillation to transfer multitask knowledge to a shared prompt matrix), since a prompt can be learned on a source task and transferred to a target task (domain) where data is available for the first task but insufficient (or no) data is available for the second task.

Optionally, the one or more target tasks include natural language processing, advantageously improving the performance of a computerized conversational system in cases where little or no data is available for a certain domain.

In one aspect, a computer program product comprises one or more tangible computer-readable storage media and program instructions stored on at least one of the one or more tangible computer-readable storage media, the program instructions executable by a processor, the program instructions comprising decomposing a source task prompt of each of a plurality of source tasks as a multiplication of a shared prompt matrix shared across the source tasks and a low-rank task-specific matrix; performing prompt distillation to transfer multitask knowledge to the shared prompt matrix by distilling knowledge from the source task prompts; and performing low-rank multiplicative updates to the shared prompt matrix to transfer the multitask knowledge to one or more target tasks; and carrying out the one or more target tasks in accordance with the transferred knowledge.

In one aspect, an apparatus comprises a memory and at least one processor, coupled to the memory, and operative to perform operations comprising decomposing a source task prompt of each of a plurality of source tasks as a multiplication of a shared prompt matrix shared across the source tasks and a low-rank task-specific matrix; performing prompt distillation to transfer multitask knowledge to the shared prompt matrix by distilling knowledge from the source task prompts; and performing low-rank multiplicative updates to the shared prompt matrix to transfer the multitask knowledge to one or more target tasks; and carrying out the one or more target tasks in accordance with the transferred knowledge.

As used herein, “facilitating” an action includes performing the action, making the action easier, helping to carry the action out, or causing the action to be performed. Thus, by way of example and not limitation, instructions executing on a processor might facilitate an action carried out by instructions executing on a remote processor, by sending appropriate data or commands to cause or aid the action to be performed. Where an actor facilitates an action by other than performing the action, the action is nevertheless performed by some entity or combination of entities.

Techniques as disclosed herein can provide substantial beneficial technical effects. Some embodiments may not have these potential advantages and these potential advantages are not necessarily required of all embodiments. By way of example only and without limitation, one or more embodiments may provide one or more of:
improvements to the technological process of machine learning by generating, using prompt decomposition and distillation, a transferable prompt to enable parameter-efficient transfer learning to a target task;
a prompt can be learned on a source task and transferred to a target task (domain) in a conversational system where data is available for the first task but insufficient (or no) data is available for the second task, thereby improving the technological field of computerized conversational systems in cases where available data is limited (e.g., using prompt distillation to transfer multitask knowledge to a shared prompt matrix);
prompt tuning that outperforms state-of-the-art methods, including the full finetuning baseline in some cases, despite only tuning 0.035% as many task-specific parameters;
parameter-efficient methods for model tuning, where the goal is to learn only a small number of additional parameters per task while achieving performance comparable to full model finetuning;
a transferable prompt learned via prompt decomposition and distillation to enable parameter-efficient transfer learning with Pretrained Language Models (PLMs);
efficient compression of task-shared knowledge into a single prompt ϕₛ to improve performance on tasks while filtering out task-specific information that is less useful for transfer learning;
efficient knowledge sharing across source tasks while still allowing each task to maintain its own parameters to encode task-specific knowledge; and
leveraging of commonalities across source tasks while minimizing interference resulting from the simple training of a single soft prompt on the source tasks.

These and other features and advantages will become apparent from the following detailed description of illustrative embodiments thereof, which is to be read in connection with the accompanying drawings.

### BRIEF DESCRIPTION OF THE DRAWINGS

The following drawings are presented by way of example only and without limitation, wherein like reference numerals (when used) indicate corresponding elements throughout the several views, and wherein:

FIG. 1A is a high-level block diagram of an example conventional approach for transferring prompt vectors from different tasks;

FIG. 1B is a high-level block diagram of an example multitask prompt tuning (MPT) system which uses multitask data to learn a single prompt that can be efficiently transferred to target tasks, in accordance with example embodiments;

FIG. 2 illustrates parameter efficiency on conventional sentence classification datasets, in accordance with example embodiments;

FIG. 3 is an illustration of prompt decomposition for two source tasks, in accordance with example embodiments;

FIG. 4 shows graphs exhibiting the results of Model Scaling, in accordance with example embodiments;

FIG. 5 shows a graph exhibiting the results of Prompt Scaling, in accordance with example embodiments;

FIG. 6 shows the visualization of cosine similarity matrices for a conventional soft prompt transfer technique and MPT on a second conventional sentence classification dataset, in accordance with example embodiments;

FIGS. 7-10 are tables illustrating example experimental results, in accordance with example embodiments;

FIG. 11 depicts a computing environment according to an embodiment of the present invention.

It is to be appreciated that elements in the figures are illustrated for simplicity and clarity. Common but well-understood elements that may be useful or necessary in a commercially feasible embodiment may not be shown in order to facilitate a less hindered view of the illustrated embodiments.

### DETAILED DESCRIPTION

Principles of inventions described herein will be in the context of illustrative embodiments. Moreover, it will become apparent to those skilled in the art given the teachings herein that numerous modifications can be made to the embodiments shown that are within the scope of the claims. That is, no limitations with respect to the embodiments shown and described herein are intended or should be inferred.

One or more embodiments advantageously provide a multitask prompt tuning (MPT) techniques which learn a single transferable prompt by decomposing and distilling knowledge from multiple task-specific source prompts. Multiplicative low rank updates to this shared prompt are learned to efficiently adapt it to each downstream target task. Extensive experiments on 21 natural language processing (NLP) datasets demonstrate that the exemplary embodiments outperform the state-of-the-art methods, including the full finetuning baseline in some cases, despite only tuning 0.035% as many task-specific parameters.

### Introduction

Finetuning Pretrained Language Models (PLMs) has led to significant improvements across various downstream NLP tasks. However, the conventional paradigm of full task-specific finetuning is difficult to scale to multiple tasks, given that contemporary PLMs can have hundreds of millions (or even billions) of parameters. There has thus been a growing interest in developing parameter-efficient methods for model tuning, where the goal is to learn only a small number of additional parameters per task while achieving performance comparable to full model finetuning.

Prompt tuning (PT), which prepends continuous prompt vectors to the input, has emerged as a promising approach for parameter-efficient transfer learning with PLMs. PT freezes the PLM parameters and only learns a small set of task-specific prompt vectors. Despite their impressive performance, there is still a large gap between prompt tuning and full finetuning for many models and tasks. Prompt vectors trained using only task-specific training data are more sensitive to initialization and require significantly more training time than fine-tuning. Instead of retrieving or aggregating source prompts, an exemplary MPT system learns a single transferable prompt exploiting rich cross-task shared knowledge. The transferable prompt is learned via prompt decomposition and distillation to enable parameter-efficient transfer learning with PLMs.

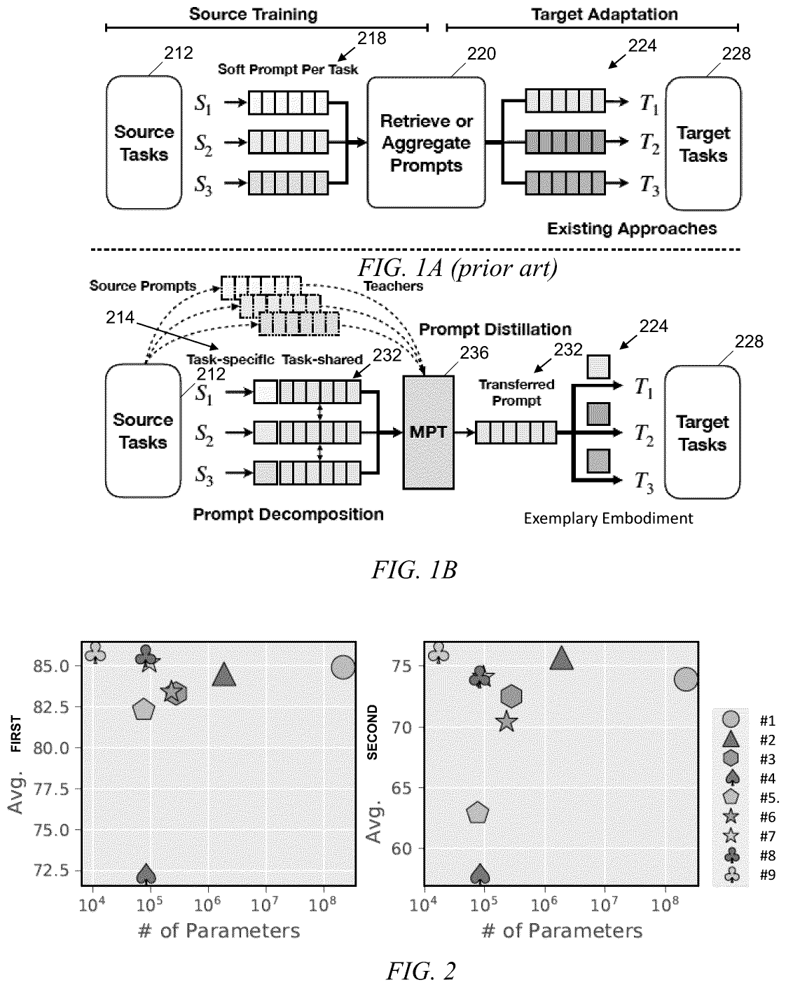

FIG. 1A is a high-level block diagram of an example conventional approach for transferring prompt vectors from different tasks. The method first trains soft prompts 218 on multiple source tasks 212 and then retrieves or aggregates 220 the soft prompts 218 to generate task prompts 224. Pretrained prompts are then used to initialize the corresponding prompt 224 for further finetuning on a target task 228 based on a (potentially learned) similarity measure.

FIG. 1B is a high-level block diagram of an example multitask prompt tuning (MPT) system 236 which uses multitask data to learn a single shared prompt 232 that can be efficiently transferred to target tasks 228, in accordance with example embodiments. (It is noted that, while shared prompt 232 and task-specific components 214 are depicted as inputs to MPT 236, MPT 236 both generates and utilizes shared prompt 232 and task-specific components 214.) While conceptually simple, learning a shared prompt space can be challenging in practice, as it requires learning commonalities across source tasks 212 while minimizing interference. The soft prompt of each source task 212 (which can be represented as a prompt matrix) is decomposed as a multiplication of a shared matrix (depicted as task-shared prompt 232 on the left side of FIG. 1B and, equivalently, as transferred shared prompt 232 on the right side of FIG. 1B) and a low-rank task-specific matrix (depicted as task-specific component 214 on the left side of FIG. 1A), and this decomposition is found to be more effective than simply sharing the prompt matrix across all tasks. This decomposition is learned through knowledge distillation from soft prompts obtained from regular prompt tuning for each source task 212. To transfer to new tasks 228, low-rank multiplicative updates are performed to the shared prompt matrix.

Extensive experiments on 21 NLP datasets across diverse tasks demonstrate the effectiveness of exemplary embodiments of the MPT approach over state-of-the-art prompt transfer methods. On a second conventional sentence classification benchmark, exemplary embodiments of the MPT approach with a conventional NLP transformer model (referred to as NLPTM herein) yields a 16.3 point improvement over the vanilla prompt tuning baseline (PT), and also outperform the most competitive multitask prompt transfer baseline, despite tuning many fewer task-specific prompt parameters (77.6K vs 232K). On some benchmarks, exemplary embodiments of the MPT approach exceed the performance of full finetuning while only requiring 0.035% tunable parameters per task. FIG. 2 illustrates parameter efficiency on a first conventional sentence classification benchmark and a second conventional sentence classification benchmark, in accordance with example embodiments. (All results are based on a NLPTM-Base model.) An asterisk indicates multitask training on target tasks. An exemplary embodiment of the MPT approach—which transfers a single shared prompt 232 learned from multiple source tasks 212 using prompt decomposition and distillation-outperform all the existing prompt tuning methods and full model finetuning (FT), despite updating many fewer task-specific parameters.) We have found that exemplary embodiments of the MPT approach are very effective for few-shot learning with 4-32 labels. Finally, ablation studies further show that exemplary embodiments of the MPT approach match the performance of full finetuning at different model scales ranging from 60M to 770M parameters.

### Parameter-Efficient Transfer Learning

Unlike existing works, exemplary embodiments of the MPT approach learn a single shared prompt 232 by decomposing and distilling knowledge from source prompts in a structured way for efficient adaptation to a diverse set of target tasks.

### Multitask Learning

While exemplary embodiments of the MPT approach are inspired by multitask learning methods, a pertinent aspect herein is on multi-task prompt transfer for parameter-efficient adaptation of language models, which still remains as a challenging and largely under-addressed problem.

### Knowledge Distillation

Exemplary embodiments of the MPT approach leverage multitask learning to better exploit the rich cross-task knowledge in prompt transfer.

### Methodology

Given a set of source tasks S={S₁, S₂, . . . , Sₖ} and target tasks T={ [symbol] , . . . , [symbol] }, a goal is to learn a single soft prompt 232 over S that can be efficiently updated to enable better performance on T. Simply training a single soft prompt on S is sub-optimal as it can fail to leverage commonalities across source tasks 212 while minimizing interference. To this end, the multitask prompt tuning (MPT) aims to efficiently compress task-shared knowledge in S into a single prompt ϕₛ to improve performance on T while filtering out task-specific information that is less useful for transfer learning.

### Prompt Tuning

Given a pre-trained language model with parameters Θ and one target task [symbol] with training data (X, Y)={xᵢ, yᵢ}ᵢ₌₁^{N}, directly finetuning all the parameters by maximizing the conditional probability P(Y|X; Θ) is expensive and often tends to overfit on small datasets. An alternative to finetuning, which is more parameter-efficient, is prompt tuning (PT), which randomly initializes a small number of learnable prompt vectors (i.e., soft prompts) to be prepended to the input embeddings of the PLM while freezing model parameters Θ. Formally, for a sequence of input tokens with token embeddings as x={t₁, t₂, . . . , tₙ}∈ [symbol] ^{n×d}, PT prepends the soft prompt P∈ [symbol] ^{l×d} with the same dimension as the token embedding d and vector length as l. Then PT optimizes the following loss function:

$${ℒ}_{PLM} = - {\sum }_{i} log P ( {y}_{i} \vert [ P ; {x}_{i} ] ; Θ ) , \qquad ( 1 )$$

with respect to P. While this approach has been successful on some tasks and models, researchers have observed that conventional PT can sometimes lead to lower performance (especially on smaller PLMs), be slow to converge, and have high sensitivity to the initialization. Recent works address these issues by first training prompts on multiple source tasks 212, and then initializing the prompts for a target task 228 via some similarity measure or learned attention. In example embodiments, a novel framework is disclosed for transferring multitask knowledge into a single soft prompt 232 to enable more performant and parameter-efficient transfer learning to downstream target tasks T 228.

### Multitask Prompt Tuning

An exemplary MPT framework includes two stages: source training and target adaptation. The exemplary MPT framework first focuses on the source training to generate a single soft prompt 232 to be reused in the second stage for target task adaptation. Specifically, task prompts for source tasks 212 are decomposed into a task-shared component 232 and a low-rank task-specific component 214 (prompt decomposition), where the former is shared across all tasks 212, and the latter is task-specific. Prompt distillation is also used to better transfer multitask knowledge to the shared component by distilling knowledge from multiple tasks-specific source prompts. Once learned, the shared prompt matrix is adapted to a downstream target task 228 via low-rank multiplicative updates.

### Prompt Decomposition

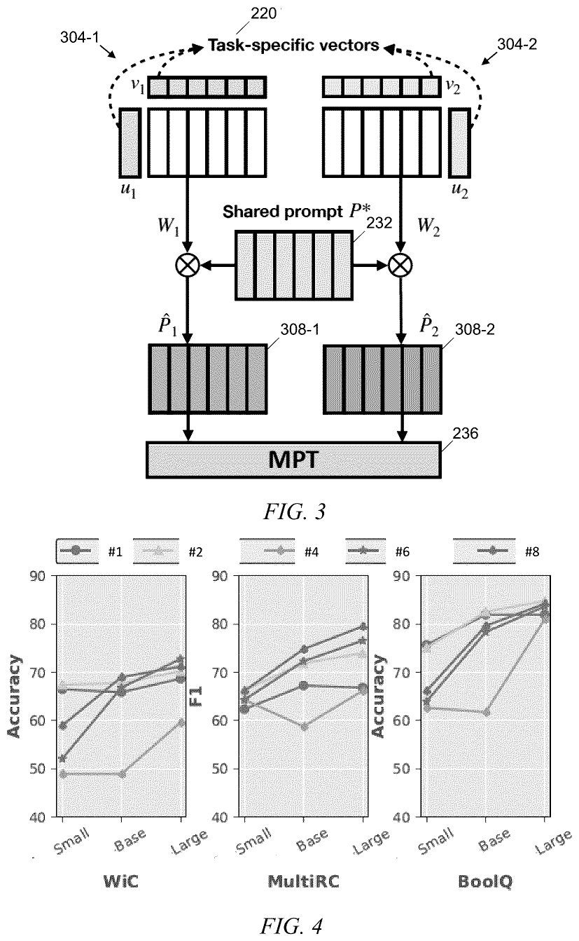

FIG. 3 is an illustration of prompt decomposition for two source tasks 212 (seen in FIG. 1B), in accordance with example embodiments. The goal of prompt decomposition is to enable efficient knowledge sharing across S while still allowing each task 212 to maintain its own parameters to encode task-specific knowledge. Specifically, the soft prompt Pₖ is decomposed for a k-th task into two parts, as shown in FIG. 3. Let P*∈ [symbol] ^{l×d} denote the shared prompt 232 (seen in FIG. 1B) across all tasks 212, and further let uₖ∈ [symbol] ^{l}, vₖ∈ [symbol] ^{d} be the task-specific vectors 304-1, 304-2 for each task k. The task-specific vectors 304-1, 304-2 form a rank-one matrix Wₖ=uₖ·vₖ^{T}, which has the same dimension as the shared prompt P*. The final task prompt \hat{P} 308-1, 308-2 for the k-th source task 212 is then parameterized as:

$${\hat{P}}_{k} = {P}^{*} ∘ {W}_{k} = {P}^{*} ∘ ( {u}_{k} \cdot {v}_{k}^{T} ) \qquad ( 2 )$$

where ∘ denotes the Hadamard product between two matrices. The disclosed parameterization of prompt decomposition captures general information of S by “slow” weights P* shared across tasks and “fast” weights Wₖ that encode task-specific knowledge in a low-rank subspace.

### Prompt Distillation

Knowledge distillation from separately-trained source prompts was found to be an effective strategy for learning good decomposable prompts. Specifically, a teacher prompt Pₖ^{t} for the k-th source task is first obtained by conventional prompt tuning. A corresponding student prompt is then randomly initialized as [symbol] =P*∘(uₖ·vₖ^{T}), where all student prompts share P* and have their own task-specific vectors 304-1, 304-2, as described above.

Distillation losses are designed to transfer cross-task knowledge into the shared prompt matrix. The first loss is to match the output probability distributions of students and teachers through minimizing their KL-Divergence,

$${ℒ}_{Logits} = {\sum }_{k} {\sum }_{i ∈ {S}_{k}} KL ( P ( {y}_{i} \vert [ {P}_{k}^{t} ; {x}_{i} ] ) , P ( {y}_{i} \vert [ ; {x}_{i} ] ) ) . \qquad ( 3 )$$

A temperature T is used to control the smoothness of the output distribution for both teacher and student models as

$${p}_{j} = \frac{1}{z} exp ( {z}_{j} / T ) ,$$

where zᵢ is the logit score for class j and Z is the normalization factor. There is also an additional mean squared loss on teacher model hidden states,

$${ℒ}_{Hidden} = {\sum }_{k} {\sum }_{i ∈ {S}_{k}} {( {H}_{ki}^{s} - {H}_{ki}^{t} )}^{2} , \qquad ( 4 )$$

where Hₖᵢ^{s}, Hₖᵢ^{t} denotes the hidden states of teacher and student networks, respectively, including a sequence of hidden vectors for the i-th input. Such additional distillation loss from intermediate states has been shown to improve results in distilling PLMs. Finally, the disclosed total loss function to train student source prompts for obtaining a single shared prompt 232 to be transferred to the target side is formulated as follows:

$${ℒ}_{Total} = {ℒ}_{PLM} + λ ( {ℒ}_{Logits} + {ℒ}_{Hidden} ) , \qquad ( 5 )$$

where [symbol] _{PLM}=Σₖ [symbol] _{PLM}^{k} represents the aggregated task losses for all source tasks 212, and λ is a weight to balance the impact of distillation loss terms.

### Source Training and Target Adaptation

In one or more embodiments, training the single source prompt 232 to be transferred to target tasks 228 includes two steps. First, the teacher prompts for all source tasks 212 are pretrained individually through conventional prompt tuning. Then, multitask training is conducted on S to jointly learn the single shared prompt 232 via the knowledge distillation loss function in Equation 5. A simple stochastic task sampling strategy, which dynamically changes the number of tasks per batch, is also adopted in one or more embodiments. In particular, for each batch of multitask samples, a number k is randomly selected from [2, κ] first, then k tasks are randomly chosen from S and their corresponding samples to constitute mini-batches. Such dynamic task sampling strategies are common in the PLM multitask learning literature.

For target adaptation, initialize the target prompt to be the Hadamard product of the shared prompt 232 and the low-rank target prompt matrix and optimize with the regular task loss in Equation 1. Exemplary embodiments can also be used for multitask learning on target tasks 228 to enable more parameter-efficient adaption of pretrained language models.

### Parameter-Efficiency

Exemplary MPT methods are parameter-efficient during both source training and target adaptation. Each task contains the shared prompt l×d that has the same dimensions as a vanilla soft prompt and a smaller number of task-specific vectors (l+d). Thus, the total number of tunable parameters for a single target task 228 is (l×d)+(l+d). For a group of target tasks 228, the total number of tunable parameters is (l×d)+(l+d)τ, where τ is the number of target tasks 228. Different methods in terms of the number of trainable parameters are listed and compared in the table of FIG. 7. (Pearson Correlation was adopted as evaluation metrics. “param/task” represents a number of trainable parameters for each task in a first conventional sentence classification benchmark. The top part of the table of FIG. 7 denotes model adaptation to each target task 228 (so param/task for MPT is just (l×d)+(l+d)). The bottom part (marked by *) denotes model adaptation to a group of tasks, where the param/task for MPT* is (l×d)/τ+(l+d). See section entitled Source Training and Target Adaptation.)

### Experiments

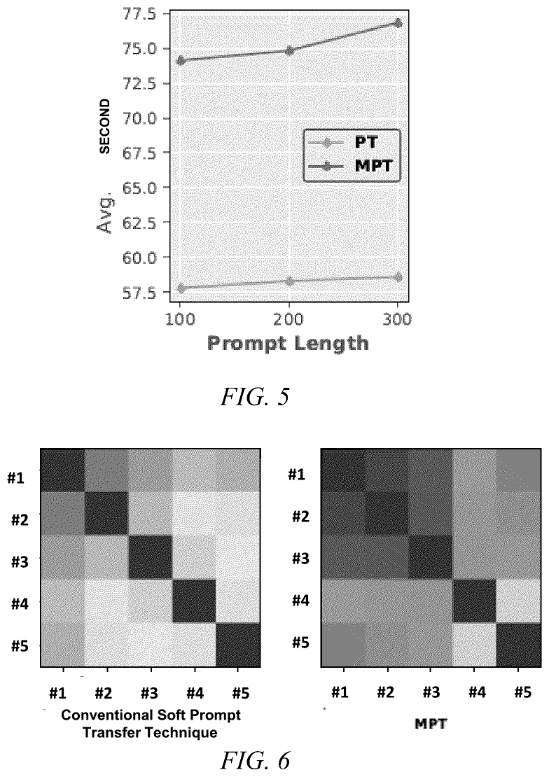

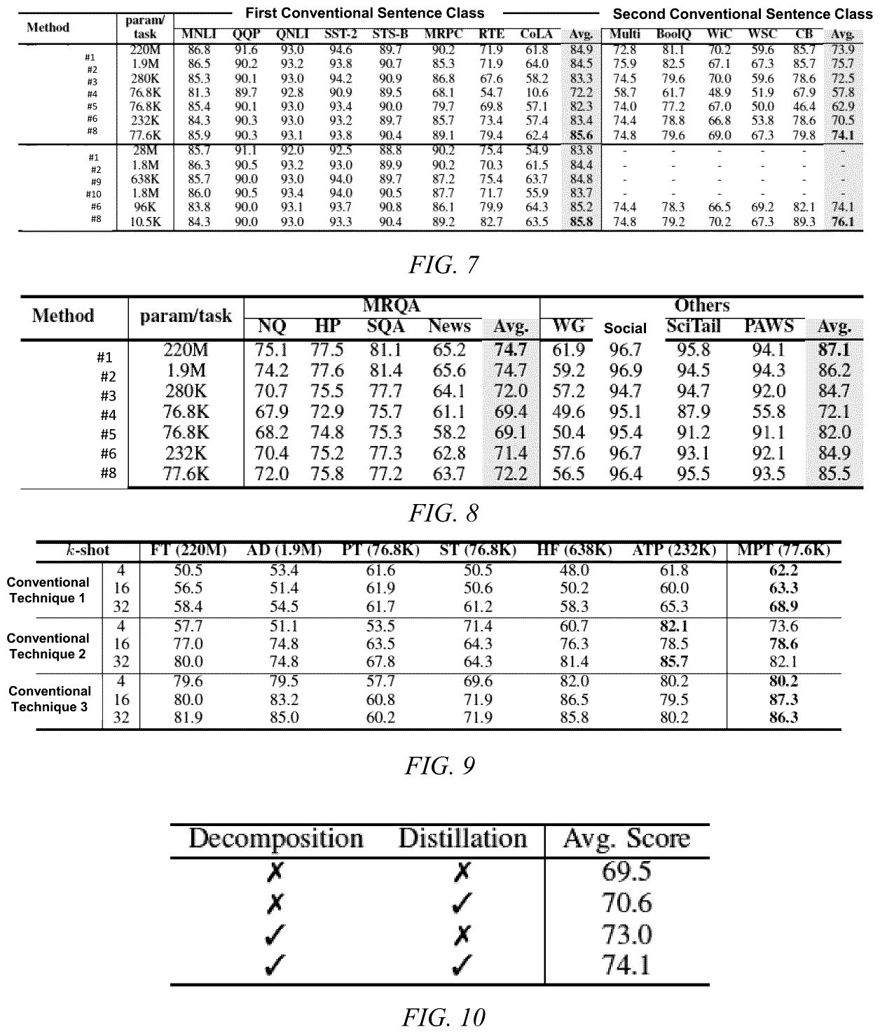

FIG. 4 shows graphs exhibiting the results of Model Scaling, in accordance with example embodiments. (With the increase of backbone PLM sizes (from NLPTM-Small to NLPTM-Large), the performance of exemplary embodiments of MPT is improved consistently across tasks.) FIG. 5 shows a graph exhibiting the results of Prompt Scaling, in accordance with example embodiments. (It is noted that increasing prompt length can effectively boost MPT performance.) Extensive experiments were conducted on 21 diverse NLP datasets to show that MPT outperforms strong baselines in both full-dataset (Tables of FIGS. 7 and 8, respectively) and few-shot adaptation settings (table of FIG. 9), while achieving more parameter-efficiency compared to existing methods (see FIG. 2). Comprehensive ablation studies and analysis were also performed to better understand the effect of model sizes (see FIG. 4), prompt length (see FIG. 5) and different components in the MPT approach (table of FIG. 10).

### Experimental Setup

### Datasets and Tasks

Performance of MPT using 6 datasets with more than 100 k annotations as source tasks and 21 datasets from four benchmarks as target tasks was evaluated.

### Models

Following the standard prompt tuning, pertinent experiments were conducted using the publicly available pretrained NLPTM-Base model with 220M parameters. In the ablation, NLPTM-Small and NLPTM-Large with 60M and 770M parameters, respectively, were also considered to empirically analyze the effect of model size on MPT performance in FIG. 4.

Baselines. An exemplary embodiment was compared with the following baselines: (1) Full finetuning (FT), where all the model parameters are tuned during adaptation on each downstream task, (2) vanilla prompt tuning (PT), where target prompt vectors are initialized by randomly sampled top vocabularies, (3) existing prompt transfer methods, including a conventional soft prompt transfer technique and the most competitive multitask prompt transfer baseline, that initialize target prompts by retrieving or aggregating source prompts, (4) popular parameter-efficient methods. On the first conventional sentence classification benchmark, an example embodiment was also compared with several state-of-the-art methods that adapt a pretrained model to all the target tasks using multitask learning.

### Implementation Details

For all datasets, the development set was used as the testing set if the original testing set was not publicly available. The original development set is split into the development and testing set if the training set is small; otherwise, a development set is separated from the training set and the original development set is used for testing. For source training, MPT was trained on the mixture of source tasks for 5 epochs with the examples—proportional mixing strategy and stochastic task sampling described in the section entitled Source Training and Target Adaptation. For prompt distillation, the hidden state loss was calculated for hidden states from both the encoder and decoder of NLPTM.

For target adaptation, the shared prompt from MPT was reused and averaged source task-specific vectors were taken to initialize the target task-specific vector. Twenty epochs were trained on small datasets, ten epochs were trained on large (more than 10 k examples) datasets, and five epochs were trained on a conventional reading comprehension dataset. All the experiments were run three times with different random seeds and the mean numbers reported. During source training, the default learning rate was set as 0.3 for both task-shared and task-specific components. However, during target adaptation, a strategy of two-speed learning rates was used for those two components. The learning rate was set to 0.3 and 0.4, respectively, for task-shared and task-specific components during adaptation for each target task. The default number of tunable tokens per each prompt was set as 100 and the teacher and student prompts were initialized by randomly sampling tokens from NLPTM's vocabulary. The default batch size for NLPTM-Base was set as 32 and, for model scaling experiments, the batch sizes for NLPTM-Small and NLPTM-Large were set to 100 and 12, respectively. The default input length for most tasks was set to 256, except for two conventional reading comprehension benchmarks that have the input length as 348 and 512. The distillation loss coefficient λ in Equation 5 was set to 0.9 and was kept fixed for all the experiments. In few-shot experiments (as known to the skilled artisan), for each number of shots k, random sampling from the training set was conducted ten times with different random seeds and the mean performance was reported. The performance on three target tasks with the same validation and testing sets in the full-dataset setting was reported. One modern, advanced commercial data center graphics processing unit (GPU) (32 GB) was used for training models on the small datasets and six GPUs were used for training models on the larger datasets.

### Results and Analysis

Full-Dataset Adaptation. The tables of FIGS. 7 and 8, respectively, show the per-task performance of different methods on all four benchmarks. As seen from the table of FIG. 7 (top part), MPT establishes new state-of-the-art results for parameter-efficient finetuning on both the first conventional sentence classification and the second conventional sentence classification benchmarks. When compared to vanilla PT, MPT obtains more than +10% points improvement on average performance (+13% on the first second conventional sentence classification benchmark, +16% on the second conventional sentence classification benchmark) with the same number of task-specific parameters, which demonstrates that multitask prompt tuning provides an effective means of improving the performance of PT, especially on small datasets. MPT consistently outperforms the conventional soft prompt transfer technique to obtain an average of 85.6% on the first conventional sentence classification benchmark and 74.1% on the second conventional sentence classification benchmark, which is +3.3% and +11.2% point accuracy improvements, respectively. Furthermore, the disclosed approach achieves 2.1% and 3.6% average accuracy improvements over the most competitive multitask prompt transfer baseline despite updating 3× fewer parameters on the first conventional sentence classification benchmark and the second conventional sentence classification benchmark, respectively. Similarly, when comparing against a conventional sparse-finetuning method, which only tunes the bias vectors, MPT outperforms it by +2.3% on the first conventional sentence classification benchmark and +3.6% on the second conventional sentence classification benchmark, while tuning 2× fewer parameters for each target task. Among the compared methods, MPT is the most competitive in terms of average accuracy on both benchmarks. MPT also outperforms a conventional extensible transfer learning method on the first conventional sentence classification benchmark with 4× fewer task-specific parameters. More surprisingly, the MPT approach outperforms the full model finetuning baseline on both benchmarks, despite tuning 0.035% as many task-specific parameters (see FIG. 2 for a comparison between different methods versus their number of updated parameters on the first conventional sentence classification and the second conventional sentence classification benchmarks).

When compared with state-of-the-art multitask baselines which train a single model on different target tasks, the table of FIG. 7, bottom part shows that MPT* (with prompt decomposition on target tasks) performs well and also further improves upon the single target task baseline. This reveals the potential of the disclosed method to further leverage multitask knowledge on the target side to enable even more parameter-efficient adaptation of pretrained language models.

The table of FIG. 8 shows the performance of different methods on the conventional reading comprehension benchmark and another conventional benchmark. (MPT outperforms the most competitive multitask prompt transfer baseline on both benchmarks, while tuning 67% less parameters). The MPT approach significantly improves the average performance of PT by +2.8% on conventional reading comprehension dataset and +13.5% on the other conventional benchmark, while adding only 0.01% more task-specific parameters. Similarly, MPT obtains 85.5% average accuracy, outperforming the conventional sparse-finetuning method (84.7%), which updates 10× more task-specific parameters. While the improvements achieved by the MPT approach (being highly parameter-efficient) are encouraging on both the first conventional sentence classification benchmark and the second conventional sentence classification benchmark, the accuracy gap between MPT and the full finetuning is still significant here (2.2% on the conventional reading comprehension dataset and 1.6% on the other conventional benchmark).

Few-Shot Adaptation. In addition to the full dataset adaptation on four benchmarks, few-shot experiments were conducted on a number of conventional tasks to measure how pretrained MPT prompts can be generalized to new tasks with only a few training examples available (k=4, 16, 32). The table of FIG. 9 shows the results of the MPT approach and other baselines. As can be seen from the table of FIG. 9 (Few-Shot Results with k={4, 16, 32}), vanilla PT performs poorly in few-shot adaptation, suggesting randomly initialized prompts are hard to generalize to new tasks with only a few shots. The conventional soft prompt transfer technique improves the performance of PT on the conventional tasks, and MPT outperforms both PT and the conventional soft prompt transfer technique. It was also observed that other methods in the table of FIG. 9 have trouble in the few-shot setting. These results indicate that MPT can effectively use cross-task knowledge in source tasks to target tasks where there are only a few labeled examples. (FIG. 9: FT: Finetuning, AD: conventional extensible transfer learning method, PT: Prompt tuning, ST: the conventional soft prompt transfer technique, HF: a conventional transformer, ATP: the most competitive multitask prompt transfer baseline. Numbers in brackets denote the number of parameters tuned for each task. The disclosed MPT consistently outperforms PT by a very large margin and competitive or even better than existing methods on majority of the cases, while tuning much fewer task-specific parameters.)

### Scaling

Scaling experiments were conducted to analyze how MPT performs with increasing pre-trained model sizes on three the second conventional sentence classification tasks. FIG. 4 shows the performance of MPT as well as full model finetuning (FT), prompt tuning (PT), and the most competitive multitask prompt transfer baseline with three different NLPTM models (NLPTM-Small, NLPTM-Base, NLPTM-Large). Experiments show that MPT can greatly benefit from scaling up the backbone model and outperforms PT and the most competitive multitask prompt transfer baseline consistently across all model sizes. These results show that a prompt decomposition strategy according to one or more embodiments is not only able to achieve the best parameter efficiency but also effective across different model scales ranging from 60M to 770M parameters.

In addition to increasing model sizes, the length of the prompt l was also increased to add more parameters and compare it with vanilla PT on the second conventional sentence classification benchmark. FIG. 5 compares PT and MPT over various prompt lengths l={100, 200, 300}. From FIG. 5, it was observed that increasing the prompt length for PT only produces marginal improvement, which is consistent with recent findings. On the other hand, exemplary embodiments of the MPT approach can obtain consistent improvements over various lengths of prompts which indicates the potential of increasing prompt length in the disclosed multitask prompt tuning to encapsulate massive scale source datasets for learning better transferable prompts.

### Analyzing Learned Prompts

Qualitative analysis was conducted on prompts learned using MPT to investigate whether cross-task knowledge is indeed encoded in the task-shared prompt which makes it easier for target tasks to effectively adapt and encode their own knowledge effectively.

Task embedding was leveraged to compute cosine similarities between all target task pairs after adaptation, where each task is represented by the composition of task-shared and task-specific prompts (averaged to obtain a single vector). FIG. 6 shows the visualization of cosine similarity matrices for the conventional soft prompt transfer technique and MPT on the second conventional sentence classification tasks, in accordance with example embodiments. It was found that task embeddings can effectively cluster similar tasks together. Moreover, it was also observed that MPT has clearer clusters than the conventional soft prompt transfer technique, which verifies the hypothesis that MPT helps target tasks to encode task-specific knowledge more effectively.

### Ablation Studies

Extensive ablation studies were conducted to measure the importance of various components of MPT and justify several important modeling strategies in an exemplary framework, in the following subsections.

Effectiveness of Prompt Decomposition. The table of FIG. 10 presents exemplary ablation studies on the second conventional sentence classification benchmark for testing the effect of prompt decomposition and prompt distillation. All the hyper-parameters were fixed across settings and MPT source training was rerun to get various ablated versions of the transferred prompt. First, both prompt decomposition and distillation were ablated and a vanilla prompt was initialized to be shared across all source tasks (no task-specific vectors). It was trained with the simple mixing of all datasets, then the resulting prompt was transferred to target tasks for adaptation. The table of FIG. 10 shows that simply training a single soft prompt only produces an average accuracy of 69.5% on the second conventional sentence classification benchmark (top row), as it fails to leverage commonalities across source tasks while minimizing interference. To measure the effect of prompt decomposition, the vanilla source prompt was replaced with an exemplary decomposable prompt with task-shared and task-specific components and was trained without prompt distillation (third row in the table of FIG. 10), which gives a 3.5% average performance improvement on the second conventional sentence classification benchmark. This ablation indicates the importance of the disclosed prompt decomposition strategy in MPT and demonstrates that the shared component can effectively capture the rich cross-task knowledge to be beneficial to target downstream tasks.

### Effectiveness of Prompt Distillation

To test the effect of prompt distillation, prompt decomposition was ablated and a vanilla prompt shared by all the source tasks 212 was trained with the same training loss of MPT in Equation 5. The teacher models are kept the same for this ablation and MPT. Compared with the simple baseline (first row in in the table of FIG. 10), adding prompt distillation (second row) produces 1.1% average performance improvement, which verifies the effectiveness of prompt distillation. With distillation, the vanilla shared prompt can be trained by more fine-grained learning signals from each task, but without prompt decomposition, knowledge of all the source tasks 212 is entangled together, which may hurt transfer performance on target tasks 228. Finally, it was observed that prompt distillation combined with prompt decomposition yields the best average performance of 74.1% on the second conventional sentence classification benchmark. This confirms that distilling knowledge from separately-trained source prompts is an effective strategy for learning good decomposable prompts.

The individual components of prompt distillation were further investigated to see their influences on final performance. The loss of hidden states was removed from Equation 5 and it was found that it produces an average performance of 73.68% on the second conventional sentence classification benchmark, verifying the effectiveness of regularizing hidden states in conjunction with logits to reach its full performance. A variant of distillation loss to match the teacher and student prompts directly was considered by adding an MSE loss to minimize the distance between those two prompts. Replacing the disclosed distillation losses with this prompt distance loss and jointly training it with prompt decomposition yields an average second conventional sentence classification benchmark performance of 73.6%, which performs worse than the distillation losses based on logits and hidden states.

### Ablation on Target Adaptation Strategies

When transferring the shared prompt from source training to target tasks 228, MPT was ablated with the choices of how to tune the task-shared and task-specific components for target tasks 228. It was found that only updating the task-shared component (i.e., removing target task-specific vectors) or only updating task-specific vectors (i.e., freezing task-shared component) produce unsatisfied results (62.5% and 71.3% for the second conventional sentence classification benchmark, respectively). This indicates the significance of keeping both components for prompt decomposition on target adaptation.

### Effectiveness of Stochastic Task Sampling

A multitask training strategy is disclosed in the section entitled Source Training and Target Adaptation, which is to stochastically sample a various number of tasks within each mini-batch to help the shared component of MPT to be robust to task variances. Ablating this training strategy produces an average performance on the second conventional sentence classification benchmark as 73.66%, which verifies the importance of this simple multitask training strategy.

Given the discussion thus far, it will be appreciated that, in general terms, an exemplary method, according to an aspect of the invention, includes the operations of decomposing, using a hardware processor 110, a source task prompt 216 of each of a plurality of source tasks 212 as a multiplication of a shared prompt matrix shared across the source tasks 212 and a low-rank task-specific matrix; performing, using the hardware processor, prompt distillation to transfer multitask knowledge to the shared prompt matrix by distilling knowledge from the source task prompts 216; and performing, using the hardware processor, low-rank multiplicative updates to the shared prompt matrix to transfer the multitask knowledge to one or more target tasks 228. The one or more target tasks (e.g., natural language processing/conversational system) are then carried out/implemented in accordance with the transferred knowledge. Thus, the technological field of computerized conversational systems can accordingly be improved in cases where available data is limited (e.g., using prompt distillation to transfer multitask knowledge to a shared prompt matrix), since a prompt can be learned on a source task and transferred to a target task (domain) where data is available for the first task but insufficient (or no) data is available for the second task.

In one example embodiment, the decomposition is learned by performing the prompt distillation obtained from regular prompt tuning.

In one example embodiment, each source task 212 is represented as a prompt matrix.

In one example embodiment, the decomposition enables efficient knowledge sharing across source tasks 212 while still allowing each source task 212 to maintain corresponding parameters for encoding task-specific knowledge.

In one example embodiment, the decomposing of the source task prompt 216 decomposes a k-th task into two decomposition parts, where P*∈ [symbol] ^{l×d} denotes an initial shared task prompt 232 across all source tasks 212 and uₖ∈ [symbol] ^{l}, vₖ∈ [symbol] ^{d} are task-specific vectors 304-1, 304-2 for each task k, the task-specific vectors 304-1, 304-2 forming a rank-one matrix Wₖ=uₖ·vₖ^{T}, which has a same dimension as the initial shared task prompt 232.

In one example embodiment, a final shared task prompt \hat{P} 232 is parametrized for a k-th source task as:

$${\hat{P}}_{k} = {P}^{*} ∘ {W}_{k} = {P}^{*} ∘ ( {u}_{k} \cdot {v}_{k}^{T} )$$

where ∘ denotes a Hadamard product between two matrices, wherein a parameterization of prompt decomposition captures general information of a corresponding source task S 212 by weights shared across the source tasks 212 and weights Wₖ encode task-specific knowledge in a low-rank subspace.

In one example embodiment, a teacher prompt Pₖ^{t} for a k-th source task using prompt tuning is obtained and multitask training is performed on the source tasks 212 to jointly learn the single shared soft prompt 232 via a knowledge distillation loss function (Equation 5).

In one example embodiment, a corresponding student prompt is randomly initialized as [symbol] =P*∘(uₖ·vₖ^{T}), where all student prompts share P* and have corresponding task-specific vectors 304-1, 304-2.

In one example embodiment, a knowledge distillation loss is configured to transfer cross-task knowledge into the shared prompt matrix.

In one example embodiment, a first distillation loss matches output probability distributions of student models and teacher models through minimizing a corresponding KL-Divergence,

$${ℒ}_{Logits} = {\sum }_{k} {\sum }_{i ∈ {S}_{k}} KL ( P ( {y}_{i} \vert [ {P}_{k}^{t} ; {x}_{i} ] ) , P ( {y}_{i} \vert [ ; {x}_{i} ] ) ) .$$

In one example embodiment, a smoothness of an output distribution is controlled, using a temperature T, for both the teacher model and the student model as

$${p}_{j} = \frac{1}{z} exp ( {z}_{j} / T ) ,$$

where zᵢ is a logit score for class j and Z is a normalization factor and wherein an additional mean squared loss on hidden states of the teacher model is defined as:

$${ℒ}_{Hidden} = {\sum }_{k} {\sum }_{i ∈ {S}_{k}} {( {H}_{ki}^{s} - {H}_{ki}^{t} )}^{2} ,$$

where Hₖᵢ^{s}, Hₖᵢ^{t} denotes hidden states of teacher and student networks, respectively, comprising a sequence of hidden vectors for an i-th input.

In one example embodiment, a student source prompt for obtaining a single soft task prompt 232 to be transferred to a target task 228 is trained using a total loss function defined by:

$${ℒ}_{Total} = {ℒ}_{PLM} + λ ( {ℒ}_{Logits} + {ℒ}_{Hidden} ) ,$$

wherein [symbol] _{PLM}=Σₖ [symbol] _{PLM}^{k} represents aggregated task losses for source tasks 212, and λ is a weight to balance an impact of distillation loss terms.

Optionally, the one or more target tasks include natural language processing, advantageously improving the performance of a computerized conversational system in cases where little or no data is available for a certain domain

In one aspect, a computer program product comprises one or more tangible computer-readable storage media and program instructions stored on at least one of the one or more tangible computer-readable storage media, the program instructions executable by a processor, the program instructions comprising decomposing a source task prompt 216 of each of a plurality of source tasks 212 as a multiplication of a shared prompt matrix shared across the source tasks 212 and a low-rank task-specific matrix; performing prompt distillation to transfer multitask knowledge to the shared prompt matrix by distilling knowledge from the source task prompts 216; and performing low-rank multiplicative updates to the shared prompt matrix to transfer the multitask knowledge to one or more target tasks 228.

In one aspect, an apparatus comprises a memory and at least one processor, coupled to the memory, and operative to perform operations comprising decomposing a source task prompt 216 of each of a plurality of source tasks 212 as a multiplication of a shared prompt matrix shared across the source tasks 212 and a low-rank task-specific matrix; performing prompt distillation to transfer multitask knowledge to the shared prompt matrix by distilling knowledge from the source task prompts 216; and performing low-rank multiplicative updates to the shared prompt matrix to transfer the multitask knowledge to one or more target tasks 228.

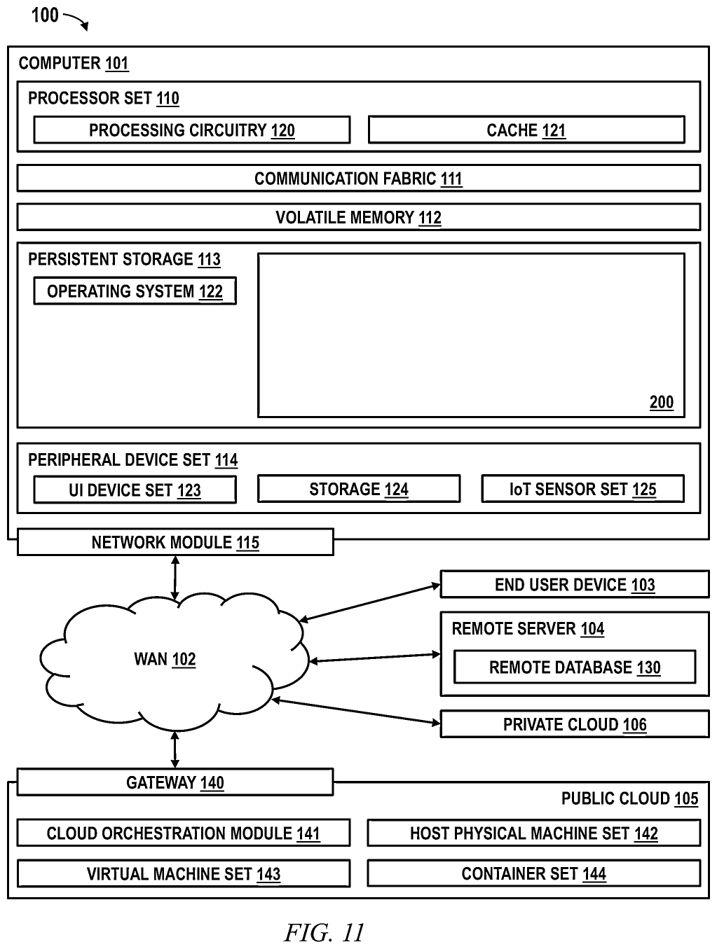

Refer to FIG. 11.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as machine learning system 200 using aspects of multitask prompt tuning for parameter-efficient transfer learning in accordance with aspects of the invention (note that aspects of the invention can use GPUs as well as conventional CPUs, as will be apparent to the skilled artisan given the teachings herein). In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method comprising:
decomposing, using a hardware processor, a source task prompt of each of a plurality of source tasks as a multiplication of a shared prompt matrix shared across the source tasks and a low-rank task-specific matrix;
performing, using the hardware processor, prompt distillation to transfer multitask knowledge to the shared prompt matrix by distilling knowledge from the source task prompts;
performing, using the hardware processor, low-rank multiplicative updates to the shared prompt matrix to transfer the multitask knowledge to one or more target tasks; and
using the hardware processor, carrying out the one or more target tasks in accordance with the transferred knowledge.

2. The method of claim 1, wherein the decomposition is learned by performing the prompt distillation obtained from regular prompt tuning.

3. The method of claim 1, wherein each source task is represented as a prompt matrix.

4. The method of claim 1, wherein the decomposition enables efficient knowledge sharing across source tasks while still allowing each source task to maintain corresponding parameters for encoding task-specific knowledge.

5. The method of claim 1, wherein the decomposing of the source task prompt decomposes a k-th task into two decomposition parts, where P*∈ [symbol] ^{l×d} denotes an initial shared task prompt across all source tasks and uₖ∈ [symbol] ^{l}, vₖ∈ [symbol] ^{d} are task-specific vectors for each task k, the task-specific vectors forming a rank-one matrix Wₖ=uₖ·vₖ^{T}, which has a same dimension as the initial shared task prompt.

6. The method of claim 5, further comprising parametrizing a final shared task prompt \hat{P} for a k-th source task as:
$${\hat{P}}_{k} = {P}^{*} ∘ {W}_{k} = {P}^{*} ∘ ( {u}_{k} \cdot {v}_{k}^{T} )$$
where ∘ denotes a Hadamard product between two matrices, wherein a parameterization of prompt decomposition captures general information of a corresponding source task S by weights shared across the source tasks and weights Wₖ encode task-specific knowledge in a low-rank subspace.

7. The method of claim 1, further comprising:
obtaining a teacher prompt Pₖ^{t} for a k-th source task using prompt tuning; and
performing multitask training on the source tasks to jointly learn the single shared soft prompt via a knowledge distillation loss function.

8. The method of claim 7, further comprising:
randomly initializing a corresponding student prompt as [symbol] =P*∘(uₖ·vₖ^{T}), where all student prompts share P* and have corresponding task-specific vectors.

9. The method of claim 7, wherein a knowledge distillation loss is configured to transfer cross-task knowledge into the shared prompt matrix.

10. The method of claim 9, wherein a first distillation loss matches output probability distributions of student models and teacher models through minimizing a corresponding KL-Divergence,
$${ℒ}_{Logits} = {\sum }_{k} {\sum }_{i ∈ {S}_{k}} KL ( P ( {y}_{i} \vert [ {P}_{k}^{t} ; {x}_{i} ] ) , P ( {y}_{i} \vert [ ; {x}_{i} ] ) ) .$$

11. The method of claim 10, further comprising controlling, using a temperature T, a smoothness of an output distribution for both the teacher model and the student model as
$${p}_{j} = \frac{1}{z} exp ( {z}_{j} / T ) ,$$
where zᵢ is a logit score for class j and Z is a normalization factor and wherein an additional mean squared loss on hidden states of the teacher model is defined as:
$${ℒ}_{Hidden} = {\sum }_{k} {\sum }_{i ∈ {S}_{k}} {( {H}_{ki}^{s} - {H}_{ki}^{t} )}^{2} ,$$
where Hₖᵢ^{s}, Hₖᵢ^{t} denotes hidden states of teacher and student networks, respectively, comprising a sequence of hidden vectors for an i-th input.

12. The method of claim 9, further comprising training a student source prompt for obtaining a single soft task prompt to be transferred to a target task using a total loss function defined by:
$${ℒ}_{Total} = {ℒ}_{PLM} + λ ( {ℒ}_{Logits} + {ℒ}_{Hidden} ) ,$$
wherein [symbol] _{PLM}=Σₖ [symbol] _{PLM}^{k} represents aggregated task losses for source tasks, and λ is a weight to balance an impact of distillation loss terms.

13. The method of claim 1, wherein the one or more target tasks comprise natural language processing.

14. A computer program product, comprising:
one or more tangible computer-readable storage media and program instructions stored on at least one of the one or more tangible computer-readable storage media, the program instructions executable by a processor, the program instructions comprising:
decomposing a source task prompt of each of a plurality of source tasks as a multiplication of a shared prompt matrix shared across the source tasks and a low-rank task-specific matrix;
performing prompt distillation to transfer multitask knowledge to the shared prompt matrix by distilling knowledge from the source task prompts;
performing low-rank multiplicative updates to the shared prompt matrix to transfer the multitask knowledge to one or more target tasks; and
carrying out the one or more target tasks in accordance with the transferred knowledge.

15. The computer program product of claim 14, wherein the decomposition is learned by performing the prompt distillation obtained from regular prompt tuning.

16. The computer program product of claim 14, wherein each source task is represented as a prompt matrix.

17. The computer program product of claim 15, wherein the decomposing of the source task prompt decomposes a k-th task into two decomposition parts, where P*∈ [symbol] ^{l×d} denotes an initial shared task prompt across all source tasks and uₖ∈ [symbol] ^{l}, vₖ∈ [symbol] ^{d} are task-specific vectors for each task k, the task-specific vectors forming a rank-one matrix Wₖ=uₖ·vₖ^{T}, which has a same dimension as the initial shared task prompt.

18. The computer program product of claim 14, wherein the one or more target tasks comprise natural language processing.

19. A system comprising:
a memory; and
at least one processor, coupled to said memory, and operative to perform operations comprising:
decomposing a source task prompt of each of a plurality of source tasks as a multiplication of a shared prompt matrix shared across the source tasks and a low-rank task-specific matrix;
performing prompt distillation to transfer multitask knowledge to the shared prompt matrix by distilling knowledge from the source task prompts;
performing low-rank multiplicative updates to the shared prompt matrix to transfer the multitask knowledge to one or more target tasks; and
carrying out the one or more target tasks in accordance with the transferred knowledge.

20. The system of claim 19, wherein the decomposition is learned by performing the prompt distillation obtained from regular prompt tuning.

21. The system of claim 19, wherein the decomposition enables efficient knowledge sharing across source tasks while still allowing each source task to maintain corresponding parameters for encoding task-specific knowledge.

22. The system of claim 19, wherein the decomposing of the source task prompt decomposes a k-th task into two decomposition parts, where P*∈ [symbol] ^{l×d} denotes an initial shared task prompt across all source tasks and uₖ∈ [symbol] ^{l}, vₖ∈ [symbol] ^{d} are task-specific vectors for each task k, the task-specific vectors forming a rank-one matrix Wₖ=uₖ·vₖ^{T}, which has a same dimension as the initial shared task prompt.

23. The system of claim 22, further comprising parametrizing a final shared task prompt \hat{P} for a k-th source task as:
$${\hat{P}}_{k} = {P}^{*} ∘ {W}_{k} = {P}^{*} ∘ ( {u}_{k} \cdot {v}_{k}^{T} )$$
where ∘ denotes a Hadamard product between two matrices, wherein a parameterization of prompt decomposition captures general information of a corresponding source task S by weights shared across the source tasks and weights Wₖ encode task-specific knowledge in a low-rank subspace.

24. The system of claim 19, further comprising:
obtaining a teacher prompt Pₖ^{t} for a k-th source task using prompt tuning; and
performing multitask training on the source tasks to jointly learn the single shared soft prompt via a knowledge distillation loss function.

25. The system of claim 19, wherein the one or more target tasks comprise natural language processing.
